(19) United States
(12) Patent Application Publication
(10) Pub. No.: US 2025/0146224 A1
(43) Pub. Date: May 8, 2025

(54) METHODS AND COMPOSITIONS FOR PAPERMAKING

(71) Applicant: SOLENIS TECHNOLOGIES, L.P., Wilmington, DE (US)

(72) Inventors: Anthony Joseph Petty, II, Glen Mills, PA (US); Matthew Wright, Weddington, NC (US); Sachin Borkar, Wilmington, DE (US)

(73) Assignee: SOLENIS TECHNOLOGIES, L.P., Wilmington, DE (US)

(21) Appl. No.: 18/938,357

(22) Filed: Nov. 6, 2024

Related U.S. Application Data
(60) Provisional application No. 63/596,531, filed on Nov. 6, 2023.

(51) Int. Cl. D21H 17/37; C08F 8/00; D21H 23/08; D21H 23/50

(52) U.S. Cl. CPC D21H 17/375; C08F 8/00; D21H 23/08; D21H 23/50

(57) ABSTRACT

A self-stabilized glyoxalated polyacrylamide (gPAM) resin composition is disclosed. The gPAM resin composition consists essentially of an aqueous reaction product of a cationic polyacrylamide (cPAM) prepolymer and glyoxal carried out in an aqueous reaction mixture having a total solids of less than a critical concentration of the gPAM resin and a pH of at least about 7.5. The cPAM prepolymer comprises a weight average molecular weight (Mw) of at least about 5,000 Da and a cationic monomer content of at least about 4, alternatively at least about 10 mol %. The reaction product is prepared without addition of any acid. The gPAM resin composition maintains a substantially single phase for a stability period of at least about 1 day after preparation, without the addition of any acid or other stabilizing compounds. Methods of preparing and using the gPAM resin composition are also disclosed.

### CROSS-REFERENCE TO RELATED APPLICATION

This application claims priority to and all benefits of U.S. Provisional Application No. 63/596,531, filed Nov. 6, 2023, the content of which is incorporated herein by reference.

### FIELD OF THE DISCLOSURE

The present disclosure relates generally to compounds and compositions for papermaking and, more specifically, to methods of making stabilized glyoxalated polyacrylamide (gPAM) resins, additive compositions prepared therewith, and methods of making and using the same.

### BACKGROUND

Papermaking is a complex process in which paper is prepared from pulp (e.g. wood), water, filler, and various chemicals. Paper manufacturing is among the most water intensive industries, as the processes include numerous stages reliant on substantial amounts of water and aqueous solutions being added to the cellulosic fibers (i.e., the “inflow stream”) to give a furnish, and eventually separated from the furnish (i.e., the “effluent stream”) to give the final product. In the course of a typical papermaking process, a relatively concentrated aqueous slurry of cellulosic material (i.e., “thick stock”) is diluted by addition of water to give a relatively diluted slurry of cellulosic material (i.e., “thin stock”), which is used to prepare a paper web that must be dewatered to give the final product. Throughout the papermaking process, various chemical additives are employed to improve particular properties of the process (i.e., “process aids”) and/or the final product being prepared (i.e., “functional aids”). Examples of processes aids include defoamers and antifoams, retention aids, biocides, drainage aids, formation aids, etc. Examples of functional additives include strength aids, e.g. for imparting temporary wet-strength (TWS), wet-strength (WS), and/or dry-strength (DS) to the final product.

In view of the number and complexity of required stages in a given papermaking process, and the number and amounts of additives utilized in each stage, there is increasing demand for additives that provide both process and functional improvements to a given processes. Unfortunately, however, achieving some sought after improvements may lead to a decrease in other performance factors. For example, achieving high retention, which can lead to improvements in the strength of the final product, can lead to reduced drainage and formation. Using conventional high molecular weight drainage aids can give excellent drainage and retention, but offer little to no strength benefits, and in some instances even result in a reduced strength due to over-flocculation. Certain DS aids like polyamidoepichlorohydrins (PAE) can give excellent dry and wet strength, but offer little to no drainage benefits and have limited repulpability. Complicating matters further, the efficiency of any given solution is strongly furnish dependent, with some of the best known dry strength and/or drainage aids failing under desired conditions, e.g. due to fines content, lignin content, and/or conductivity of the furnish system. As such, while there are programs to address these furnish derived performance reductions, there is a still present need for additives that provide exceptional dewatering and good dry strength in even the most challenging furnish systems.

One category of chemicals being increasingly explored for multi-use additive application includes glyoxalated polyacrylamide (gPAM) resins, which have been utilized in the paper industry for many years as processes aids, e.g. for improving water drainage during the papermaking process, and also as functional additives, e.g. for imparting temporary wet-strength (TWS), wet-strength (WS), and dry-strength (DS) to the final paper(s) being prepared. Typical gPAM resins are prepared by glyoxalating polyacrylamides (PAM), i.e., by reacting glyoxal with a PAM or PAM copolymer (i.e., a prepolymer). Typical prepolymers are prepared from acrylamide (AM) and a limited pool of anionic, cationic, and/or neutral monomers, e.g. to achieve a cationic polyacrylamide (cPAM) or anionic polyacrylamide (aPAM), so named based on the predominant charge of the functional monomer(s) selected.

Unfortunately, conventional synthesis of gPAM resins must be carried out at low solids and under strict pH control due to the nature of the reaction and ultimate gPAM resins, which build viscosity and gel rapidly above a critical concentration. Specifically, such processes are carried out at a basic pH to facilitate reaction between the acrylamide residues in the prepolymer and the glyoxal, which forms both pendant aldehyde groups and crosslinks the prepolymer. The reaction is maintained by keeping a basic pH, with the rate of the reaction correlating to the pH, i.e., where the reaction rate increases with higher pH. At a desired reaction endpoint, the pH is reduced with acid (e.g. H₂SO₄), which slows the crosslinking and allows for temporal stability of the product. Notably, the acid used to slow/stop the crosslinking reaction is typically the most hazardous component utilized during the process, and subject to the most regulatory and safety compliance measures. However, if the pH is not dropped in this fashion, the reaction mixture will gel within minutes of reaching the desired end point, especially under commercial conditions (i.e., off-site production) which utilize high reaction concentrations to facilitate economical storage and shipping. As such, the conventional syntheses of gPAM resins are tied to use of an acid quench to maintain a usable product. Even at the final lower pH, however, the crosslinking reaction continues, albeit slowly, to eventually produce an unusable gelled product. Accordingly, gPAM resin produced by such methods are typically characterized by a short shelf life of up to only a few weeks. Compounding this issue is the low-solids tolerance of the reaction and products, which necessitate a large volume-to-active ratio that negatively impacts the economics and logistics of production, storage, and transport of gPAM resin products.

In view of the issues above, recent efforts have been made to shift gPAM production to the place of intended use, e.g. at a customer site. Such processes are designated “on-site” and are used to mitigate the issue of storage stability and gelation. Specifically, on-site glyoxalation is generally run at a much lower concentrations, as the shipping concerns regarding the weight of water used are obviated by the proximity of a reactor to the site of use. However, these on-site processes still rely on sulfuric acid or other hazardous or corrosive alternatives to quench the reaction and maintain the integrity of the resulting product.

### BRIEF SUMMARY

A self-stabilized glyoxalated polyacrylamide (gPAM) resin composition is provided. The gPAM resin composition consists essentially of an aqueous reaction product of a cationic polyacrylamide (cPAM) prepolymer and glyoxal carried out in an aqueous reaction mixture having a total solids of less than a critical concentration of the gPAM resin and a pH of at least about 7.5. The cPAM prepolymer comprises a weight average molecular weight (Mw) of at least about 5,000 Da and a cationic monomer content of at least about 4, alternatively at least about 10 mol %. The reaction product is prepared without addition of any acid. The gPAM resin composition maintains a substantially single phase for a stability period of at least about 1 day after preparation, without the addition of any acid or other stabilizing compounds.

A method of preparing the gPAM resin composition is also provided, along with an additive composition comprising the gPAM resin composition.

A method of preparing an aqueous cellulosic composition is also provided. The preparation method comprises preparing the self-stabilized glyoxalated polyacrylamide (gPAM) resin composition by selectively glyoxalating the cPAM prepolymer in an aqueous reaction mixture having a total solids of less than about 6% and a pH of at least about 7.5 to give the gPAM resin composition at an initial state defined by an initial pH (I_{pH}), turbidity (I_{NTU}), and viscosity (I_{η}). The preparation method also comprises determining a stability period over which the gPAM resin composition reaches a final state defined by a final pH (F_{pH}), turbidity (F_{NTU}), and viscosity (F_{η}). The preparation method further comprises combining the gPAM resin composition with an aqueous suspension of cellulosic fibers, within the stability period and free from any addition of acid thereto, thereby preparing the aqueous cellulosic composition.

### BRIEF DESCRIPTION OF THE DRAWINGS

FIG. 1 is a plot of viscosity data taken during a series of glyoxalation reactions in accordance with the examples.

### DETAILED DESCRIPTION

The following detailed description is merely exemplary in nature and is not intended to limit the instant methods, compositions, processes, or products disclosed herein. Furthermore, there is no intention to be bound by any theory presented in the preceding background or the following detailed description. Conventional techniques related to the compositions, methods, processes, and portions thereof set forth in the embodiments herein may not be described in detail for the sake of brevity. Various tasks and process steps described herein may be incorporated into a more comprehensive procedure or process having additional steps or functionality not described in detail herein for being well-known and readily appreciated by those of skill in the art. As such, in the interest of brevity, such conventional steps may only be mentioned briefly or will be omitted entirely without providing well-known process details.

A self-stabilized glyoxalated polyacrylamide (gPAM) resin composition is provided. The gPAM resin composition consists essentially of an aqueous reaction product of a cationic polyacrylamide (cPAM) prepolymer and glyoxal. A method of preparing the gPAM resin composition is further provided, along with a method of method of preparing an aqueous cellulosic composition, e.g. for papermaking, using the gPAM resin composition. As will be understood, the method of preparing the aqueous cellulosic composition comprises the preparation of an additive composition that includes the self-stabilized glyoxalated polyacrylamide (gPAM) resin composition, which is then used to treat an aqueous suspension of cellulosic fibers. Accordingly, the embodiments of the present disclosure are related and centered around the gPAM resin composition described and exemplified herein.

As will be understood from the description herein, the additive composition is exemplified by the aqueous composition comprising the gPAM resin (i.e., the gPAM resin composition), which may be prepared according to the method as an in-situ process in close proximity and/or time to a desired application. Importantly, no acid treatment is utilized in preparing, stabilizing, storing, or otherwise modifying the gPAM resin composition before or during use in the method. In this fashion, the method prepares an aqueous cellulosic composition comprising a self-stabilized gPAM resin. The gPAM resin itself is a functionalized polymer prepared from a cationic polyacrylamide (cPAM) during the method, which thus provides a functionalized polymer to paper production processes and thereby process and/or product improvements based on the properties of the functionalized polymer.

As used herein, the term “self-stabilized” describes the storage and functional stability of the gPAM resin after formation without the need for treatment with strong acid (e.g. via an acid quench) or other additives intended to stabilize the gPAM resin via lowering the pH. As such, compared to conventional methods of preparing gPAM resins, the present embodiments provide a means for acid-free on-site production of gPAM that maintains functionality as a dewatering and strength additive over time. The specific performance properties related to the stability and functionality are demonstrated in the exampled herein.

In general, the embodiments are described herein in terms of the method of preparing the aqueous cellulosic composition. However, it will be appreciated that the gPAM resin composition, the additive composition including the same, and the methods of making each of the same, are also described and provided herein, including in the examples.

As a primary step, the method comprises selectively glyoxalating a cationic polyacrylamide (cPAM) prepolymer to give the gPAM resin. More specifically, the glyoxalation is carried out in an aqueous reaction mixture at low solids and a basic pH.

The cPAM prepolymer may be prepared or obtained. In some embodiments, the method comprises preparing the cPAM prepolymer. For example, the preparation may comprise reacting an acrylamide (AM) monomer, a cationic monomer, and optionally one or more additional ethylenically unsaturated monomer(s), in the presence of a chain transfer agent. However, there are multiple methods to prepare the cPAM prepolymer, which are known in the art and may be adapted from conventional methods of preparing prepolymers suitable for glyoxalation to give a gPAM resin in accordance with the parameters set forth herein. Examples include free radical polymerization in water, such as via use of a redox initiating system (e.g. sodium metabisulfite and sodium persulfate). Other combinations of redox initiating systems for initiating polymerization of suitable comonomers may also be used, including other persulfate salts such as potassium persulfate or ammonium persulfate or other components such as potassium bromate, or peroxides. Such redox initiating systems may be used in combination with a chain transfer agent, such as a sodium hypophosphite, sodium formate, isopropanol, or mercapto compound-based chain transfer agent.

The cPAM prepolymer typically includes ionic repeat units, e.g. cationic repeat units derived from the cationic monomer. The cationic comonomer may be any cationic monomer capable of reacting through radical chain polymerization with the AM monomer and/or other monomers/comonomers to form the cPAM prepolymer.

Examples of cationic monomers include tertiary and quaternary diallyl amino derivatives, or tertiary and quaternary amino derivatives of acrylic acid or (meth)acrylic acid or acrylamide or (meth) acrylamide, vinylpyridines and quaternary vinylpyridines, or para-styrene derivatives containing tertiary or quaternary aminoderivatives. Cationic comonomers may be chosen from diallyldimethylammonium chloride (DADMAC), [2-(acrylamido)ethyl] trimethylammonium chloride, [2-(methacrylamido)ethyl] trimethylammonium chloride, [3-(acrylamido) propyl] trimethyl ammonium chloride, [3-(methacrylamido) propyl] trimethyl ammonium chloride, N-methyl-2-vinylpyridinium N-methyl-4-vinylpyridinium, p-vinylphenyltrimethylammonium chloride, p-vinylbenzyltrimethylammonium chloride, [2-(acryloyloxy)ethyl] trimethylammonium chloride, [2-(methacryloyloxy)ethyl] trimethylammonium chloride, [3-(acryloyloxy) propyl] trimethyl ammonium chloride, [3-(methacryloyloxy) propyl] trimethylammonium chloride, and combinations thereof. It is understood that mixtures of cationic comonomers can be used to the same purpose. In some embodiments, the cationic monomer includes, alternatively is selected from, diallyldimethylammonium chloride (DADMAC).

The cPAM prepolymer may contain other monomer units provided by additional ethylenically unsaturated monomer(s) in the polymerization. These monomers are typically selected to not significantly interfere with the glyoxalation process. For example, additional monomer units can be selected from vinyl amides, acrylates, alkyl acrylates (e.g. methacrylates, methyl methacrylate, etc.), hydroxy alkyl acrylates, styrenes, vinyl acetates, alkyl acrylamides (e.g. N-alkyl(meth) acrylamides, N,N-dialkyl(meth) acrylamides, etc.) and the like, as well as combinations thereof. Specific examples of such monomer units include methacrylate, octadecyl(meth) acrylate, ethyl acrylate, butyl acrylate, methyl(meth) acrylate, hydroxyethyl (meth)acrylate, 2-ethylhexylacrylate, N-octyl(meth) acrylamide, N-tert-butyl acrylamide, N-vinylpyrrolidone, N,N′-dimethyl acrylamide, styrene, vinyl acetate, 2-hydroxy ethyl acrylate, acrylonitrile, and the like, and combinations thereof. It is to be appreciated that other monomers may also be used, which may be referred to using colloquial, industry, or convention-specific nomenclature. For example, while the base units of the polyacrylamide polymers herein are referred to as acrylamides, descriptions referencing “vinyl acrylamides” will be understood to likewise apply.

In certain embodiments, anionic monomers, or monomers later transformed into anionic group-containing units, are included in or as the other monomers/comonomers to form the cPAM prepolymer. It is to be appreciated that the term “cPAM prepolymer” as used herein is not limited to only cationic polymers, but instead merely denotes the presence of the cationic monomer described herein. Accordingly, it will be understood by those of skill in the art that the cPAM prepolymer may itself be amphoteric in nature, e.g. when anionic monomers are used in the polymerization and/or anionic units are present in the structure of the cPAM prepolymer. For example, in some such embodiments one or more anionic monomer is selected from vinyl acidic compounds (e.g. acrylic acid, methacrylic acid, maleic acid, allyl sulfonic acid, vinyl sulfonic acid, itaconic acid, fumaric acid, 2-acrylamido-2-methyl-propanesulfonic acid, etc.), vinyl compounds with potentially-anionic groups (e.g. maleic anhydride, itaconic anhydride), vinyl group-containing salts (e.g. alkali metal and/or ammonium salts of the acidic compounds above, sodium styrene sulfonate, etc.), as well as combinations thereof. Such anionic monomers may be described collectively as vinyl carboxylic acids and esters or salts thereof.

The cPAM prepolymer can be prepared with a linear or branched structure, and may be crosslinked or substantially non-crosslinked. It will be appreciated that in particular embodiments, the preparation method utilizes the chain transfer agent introduced above. As such, it sill be understood that the cPAM prepolymer may also be chain-transferred, or crosslinked & chain-transferred (i.e., structured).

In some embodiments, the cPAM prepolymer is crosslinked, and the preparation method comprises using a crosslinking agent. Typical examples of crosslinking agents are polyethylenically unsaturated compounds, such as methylene bis(meth) acrylamide, triallylammonium chloride, tetraallyl ammonium chloride, polyethyleneglycol diacrylate, polyethyleneglycol dimethacrylate, N-vinyl acrylamide, divinylbenzene, tetra(ethyleneglycol) diacrylate, dimethylallylaminoethylacrylate ammonium chloride, diallyloxyacetic acid, diallyloctylamide, trimethyllpropane ethoxylate triacryalte, N-allylacrylamide, N-methylallylacrylamide, pentaerythritol triacrylate, and the like, as well as salts, derivatives, and combinations thereof. Other systems and agents for crosslinking can be used instead of or in addition to the agents above. For example, covalent crosslinking through pendant groups can be achieved, e.g. by the use of ethylenically unsaturated epoxy or silane monomers, the use of polyfunctional crosslinking agents such as silanes, epoxies, polyvalent metal compounds, etc., or by other known crosslinking systems. In certain embodiments, the cPAM prepolymer is prepared using at least one of the anionic monomer units set forth above, and further crosslinked via covalently bonding a linking group using the anionic group of the anionic monomer units.

It is to be appreciated that any or all of the components above (e.g. monomers, cross-linkers, etc.) may be prepared or otherwise obtained (e.g. from commercial sources). Moreover, such components and/or the reagents used to prepare the same may originate from traditional (e.g. fossil-based) sources, or instead may be bio-based, i.e., prepared using biological methods and/or from products of such methods. In some embodiments, the method utilizes all bio-based components in the preparation of the cPAM. In other embodiments, at least a portion of a component is bio-based.

Typically, preparing the cPAM comprises radical polymerization of all monomers. Polymerization is typically carried out in an aqueous solution (e.g. in aqueous media). The polymerization may be carried out at any suitable temperature, such as at about room temperature, at a reduced temperature (e.g. below room temperature), or at an elevated temperature (e.g. at a temperature of at least about 50° C.). It is sometimes advantageous to raise the temperature after the addition of all comonomers has been completed so as to reduce the level of residual monomers in the product. It will be understood that multiple temperatures may thus be utilized. For example, an initiation temperature at or below room temperature may be employed, optionally along with a final polymerization temperature of at least about 50° C. to increase monomer incorporation. Those of skill in the art will appreciate the typical temperatures utilized at the different reaction stages, which will be independently or collectively selected to provide the particular cPAM desired. Likewise, it will be appreciated that the pH of the polymerization reaction may also be adjusted (e.g. with acids or bases, or with a buffer), and with suitable pH ranges typically being dependent on the initiator system and components used in the reaction.

Comonomers may be added all at once or added over any length of time. If one monomer is less reactive than another, then it is advantageous to add part or all of the slower reacting monomer at the start of the polymerization, followed by a slow continuous or multiple batch wise additions of more reactive monomer. Adjusting feed rates can lead to more uniformity of the compositions of polymer chains. Likewise, initiators may be added at once or added over any length of time. To reduce the amount of residual monomer in the copolymer, is often advantageous to continue adding the initiator system for some time after all monomers have been added, or to introduce batch wise additional amounts of initiator. Controlling polymer compositional and molecular weight uniformity by controlling addition times is well known in the polymer industry.

In some embodiments, the cPAM prepolymer is prepared with at least one predetermined physical property, such as cationic monomer content, weight average molecular weight (Mw), and/or reduced specific viscosity (RSV).

The cationic monomer content of the cPAM is not particularly limited. For example, the cPAM typically comprises from about 1 to 98 mol % of cationic monomer units. In some embodiments, the cPAM comprises from about 1 to about 50, alternatively from about 2 to about 40, alternatively from about 3 to about 30, alternatively from about 3 to about 25, alternatively from about 4 to about 25 mol % of repeat units derived from the cationic monomer. However, it is to be understood that amounts outside these ranges may also be utilized. In general embodiments, the cPAM prepolymer comprises a cationic content, expressed as a mol % of repeat units attributed to cationic monomers, of at least about 4 mol %. In some, embodiments the cPAM prepolymer comprises greater than 4 mol % cationic units, such as at least about 10, alternatively of at least about 15, alternatively of at least about 20 mol % of cationic monomer units.

The cPAM may be prepared in a wide-range of molecular weights, such as a weight-average molecular weight (Mw) of from about 5 to about 500 kDa (e.g. via size-exclusion chromatography (SEC)). Particular values outside this Mw range may also be achieved (e.g. from about 1 to about 5 kDa or greater than 500 kDa, etc.). Likewise, depending on a desired use of the cPAM, ranges overlapping or encompassed within the above range may be achieved. The particular Mw dispersity of the cPAM may thus be selected by those of skill in the art in view of the description herein based on the intended use of the cPAM, and controlled using known methods and techniques compatible with the present embodiments. Likewise, particular Mw values may be utilized on the basis of another targeted property, such as RSV. In particular embodiments, for example, the cPAM is prepared with a Mw of at least about 5,000 Da, alternatively of at least about 20,000 Da. In some embodiments, the cPAM prepolymer has a Mw from about 50 to about 250 kDA, such as from about 100 to about 175, alternatively from about 105 to about 160 kDa, each with a RSV of from about 0.90 to about 1.2 dL/g, alternatively from about 0.95 to about 1.16 dL/g. Such particular embodiments are described for exemplary purposes, as it will be readily understood that the cPAM may comprise different Mw and/or RSV values. In some embodiments, for example, the cPAM prepolymer has a Mw from about 20 to about 500 kDA, including the ranges and subranges described above. In some these or other embodiments, the cPAM prepolymer has a Mw of greater than about 5 KDa, with no practical upper limit.

The cPAM prepolymer typically has a RSV of from about 0.5 to about 1.8 dL/g, such as from about 0.6 to about 1.6 dL/g. The RSV of the cPAM prepolymer may be determined by standard procedures and processes, e.g. using an Ubbelhode-type viscometer or an automated dilute solution/Kinematic viscometer, such as a PolyVisc.

In certain embodiments, the cPAM prepolymer comprises specific combinations of the properties above. For example, in some embodiments the cPAM prepolymer comprises from about 0.3 to about 5 mol % of cationic monomer units derived from the cationic monomer and exhibits a RSV of from about 0.5 to about 1.0 dL/g. In other embodiments, the cPAM prepolymer comprises from about 10 to about 15 mol % of cationic monomer units derived from the cationic monomer and exhibits a RSV of from about 0.8 to about 1.2 dL/g. In other embodiments, the cPAM prepolymer comprises from about 15 to about 25 mol % of cationic monomer units derived from the cationic monomer and exhibits a RSV of from about 1.0 to about 1.4 dL/g. The particular selection of such properties will be informed by the glyoxalation performance, as described further below, where the turbidity of the reaction may be used to monitor and guide control of the reaction to build a desired molecular weight without compromising performance by carrying on the reaction to gelling or another state of detrimental precipitation via over polymerization/crosslinking. The cPAM prepolymer may be characterized by other properties in addition to those above, such as by charge density and/or zeta potential.

For example, in some embodiments, the cPAM prepolymer typically has a charge density of from about 0.2 to about 4 mEq./g, such as from about 0.5 to about 4, alternatively from about 1 to about 4, alternatively from about 1 to about 3.5, mEq./g, at pH 7.

As introduced above, the gPAM resin is prepared by selectively glyoxalating the cPAM, that is, reacting the cPAM with glyoxal or a suitable derivative to prepare the gPAM resin therefrom. Selectively glyoxalating the cPAM prepolymer comprises reacting the cPAM prepolymer and glyoxal. As understood in the art, the reaction cPAM prepolymers with glyoxal may be carried out under varied conditions of time, temperature, pH, etc. In the present embodiment, however, the time and pH are controlled and monitored based on the reaction itself. More specifically, as demonstrated in the Examples herein, the method may be used to selectively glyoxalate the cPAM prepolymer by controlling the concentration of the cPAM prepolymer and other components in an aqueous media during glyoxalation, as well as the pH and time of the glyoxalation reaction. Typically, the temperature is held standard, e.g. at ambient temperature. In this fashion, it has been found that the gPAM resins described herein may be prepared across a range of properties as described herein, and may be used directly without further processing.

Typically, the glyoxal is added quickly to the cPAM prepolymer to minimize crosslinking. Alternatively, the cPAM prepolymer can be added to the glyoxal. It is also generally understood in the art that the molecular weight of the cPAM prepolymer, and the ratio of glyoxal to acrylamide groups on the cPAM prepolymer, may be adjusted to achieve desired levels of crosslinking and viscosity build during a glyoxalation process.

The cPAM prepolymer (A) and the glyoxal (B) are typically reacted in a dry weight (w/w) ratio of from about 70:30 to about 95:5 (A): (B), such as from about 80:20 to about 90:10. The residual level of glyoxal in the final gPAM resin is typically below about 10%, alternatively below about 8%, alternatively below about 5%, on a dry weight basis of the gPAM resin. However, as will be understood in view of the description herein, the glyoxalation reaction carries on, even at much slower rates, in the “product” gPAM resin, such that residual glyoxal may be consumed over time.

The glyoxalation reaction is carried out under basic conditions, i.e., at a pH greater than 7.0. As understood by those of skill in the art, the rate of reaction between the acrylamide residues in the cPAM prepolymer and the glyoxal, which forms both pendant aldehyde groups and crosslinks the prepolymer, is pH dependent, where a higher pH corresponds to a higher rate of reaction.

Typically, the glyoxalation reaction is carried out at a pH of at least about 7.5, alternatively of at least about 8. In some embodiments, a pH of at least about 8.5, alternatively at least about 9, at least about 9.5 is utilized. The particular pH will be dependent on the specific reaction conditions, and will vary over time as demonstrated in the examples. For example, it is well known in the art that the glyoxalation reaction proceeds in a pH and temperature relationship, whereby one can modify one or both reaction properties to influence the reaction progress over time. As such, it is to be understood that the description herein relating to the selection and/or effects given by modifying but one property at a time (e.g. pH) is predicated on the other properties being held consistent between the otherwise modified conditions.

The concentration of the cPAM prepolymer is selectively controlled during glyoxalation to give the self-stabilized gPAM resin composition. For example, in typical embodiments, the cPAM prepolymer is present in the aqueous media at an initial concentration of less than about 3, alternatively less than about 2% (w/w). In certain embodiments, the prepolymer is present in the aqueous media at an initial concentration of from about 0.5 to about 3, alternatively from about 0.5 to about 3, alternatively from about 0.5 to about 2.5, alternatively from about 0.5 to about 2, alternatively from about 1 to about 2%. This concentration is typically defined in terms of solids, i.e., the weight percent concentration of the starting cPAM prepolymer at the start of the glyoxalation reaction, that is when all of the glyoxal has been added.

In general, these ranges are implemented for a low-solids process, as introduced above. In such embodiments, the gPAM resin may be prepared in the aqueous media at a solids content (%) of about A+B, where A is the initial concentration of the cPAM in the aqueous media utilized in the glyoxalation, and B is a conversion factor based on one or more of the predetermined physical properties of the cPAM or a parameter of the glyoxalation reaction itself. In this fashion, the solids content of the cPAM and the solids content of the gPAM resin may be described in view of each other. Likewise, selective glyoxalation may be understood to include selecting a desired cPAM prepolymer concentration based on a desired gPAM resin solids content in the additive composition, however more typically the solids content is controlled to maintain a low reaction turbidity, thereby increasing the stability and functionality of the resulting product composition.

In some embodiments, the glyoxal concentration during glyoxalation is selectively controlled alongside the concentration of the cPAM prepolymer. For example, in specific embodiments, the glyoxal concentration is from about 0.1 to about 1% (w/w) in the aqueous media. In some embodiments, the glyoxal concentration is from about 0.1 to about 0.5, alternatively from about 0.2 to about 0.3%.

Typically the combined (total) reaction solids is maintained at below about 7, alternatively below about 6%. In some embodiments, the solids is maintained below about 5%, such as below about 4%, alternatively below about 3%. It will be understood that the solids content of the reaction is thus lower than conventional methods, which typically prefer to run the glyoxalation reaction at a higher concentration of the cPAM to optimize the efficient use of the reaction vessel and/or to obtain a final product with a higher gPAM concentration. However, the particular conditions selected in the present embodiments have been demonstrated to impart the stability and maintain the functionality of the polymers over time, in a fashion unmet by conventional methods.

In some embodiments, the glyoxalation reaction specifically comprises monitoring and selectively controlling the solids content of the reaction, in terms of the gPAM product. In other words, in such embodiments the progress of the reaction may be monitored, and the amount of gPAM being prepared may be controlled. As will be understood by the description above, the glyoxalation is carried out as a “low-solids” process. Typically, the glyoxalation reaction is carried out on-site, i.e., as an on-site process. Those of skill in the art will understand that the cut off between high-solids and low-solids processes is dynamic and relates to the identity and characteristics of the reaction components (e.g. cPAM Mw, ratio of cPAM to glyoxal, etc.). The solids value at which a process moves between a high and low solids process may be understood as the “critical concentration” of a given reaction. Parameters and properties of such process variations are set forth herein, but may be modified, supplemented, and/or replaced by other glyoxalation techniques known in the art, so long as compatible with the embodiments set forth herein. Such processes may be selected based on a desired property of the gPAM resin (e.g. Mw, viscosity, Rg, charge density, zeta potential, etc.) and/or additive composition (e.g. solids content, viscosity, etc.) being prepared, or a particular use thereof.

The monitoring of the reaction progression is not limited to any particular technique, but instead may be carried out using any known method applicable with the reaction conditions selected. For example, the reaction may be monitored according to a property directly related to the solids content of the gPAM prepared, such as the turbidity, viscosity, pH, and/or temperature of the reaction. Likewise, the reaction may be monitored according to a property indirectly related to the solids content, i.e., a property useful for monitoring the glyoxalation reaction, such as via current consumption of a circulation pump, stirrer, etc. influenced by the reaction viscosity. Such properties may be measured directly, e.g. via sampling or monitor, or instead may be monitored indirectly, e.g. via a bypass area of a reactor. It is generally known that the reaction mixture will increase in viscosity as the gPAM is being prepared. Any of such properties may be monitored over time, e.g. as a difference measurement, and multiple properties may be monitored in tandem for precise value determination and control.

Typically, the method comprises monitoring the turbidity of the reaction. In general, it is to be understood that the turbidity of the glyoxalation reaction is being used to assess the visible precipitate in the reaction mixture. During the reaction, precipitate begins to form when the molecular weight of the gPAM resin increases beyond some critical amount for that resin and the particular conditions, whereby the resin is no longer able to be solvated in the aqueous solution. As such, turbidity can be used as an indicator of molecular weight build and, therefore, reaction progress. It will be understood that the absolute turbidity of a given reaction may differ greatly from a different reaction, and thus absolute turbidity values may not be as instructive across all cases. Rather, the change in turbidity over time, as a measure of reaction progress, is typically utilized. In general, a cPAM prepolymer may exhibit a turbidity of from about 0.1 to about 10, alternatively from about 1 to about 5 nephelometric units (NTU) (e.g. at the beginning of the reaction (TO)). During the glyoxalation, the gPAM composition may exhibit a turbidity change of from about 1 to about 1000, alternatively from about 1 to about 100 NTU, alternatively of about 1 to about 10 NTU to reach a predetermined endpoint, at which time the reaction may be ceased (e.g. by stopping addition of base/caustic components, decreasing the reaction temperature, etc.). Accordingly, the determination steps of the reaction will be understood to encompass assessing the turbidity change over time for a given cPAM prepolymer and selected reaction conditions, e.g. in order to select a desired end point for the glyoxalation and tune the period of stability of the resulting gPAM composition.

Methods and parameters for using turbidity and/or viscosity to monitor glyoxalation progress and determine endpoints, especially as related to the Critical Concentration of the reaction, is described in U.S. Pat. No. 8,222,343B2, which is hereby incorporated by reference.

In certain situations, a turbidity may be difficult to assess or otherwise unavailable to monitor. In such cases, another metric may be utilized to monitor the reaction progress and select a desired end point. For example, viscosity build (i.e., change in viscosity over time) is a known method for monitoring glyoxalation reactions, and such methods may be used. It will be appreciated that both direct and indirect methods may be used, as described herein.

Once a desired end point is reached (i.e., the reaction is “complete”) or imminent, the reaction may be ceased by forgoing further additional of base and letting the reaction consume that present therein. In the present embodiments, the glyoxalation is carried out free from addition of acid. Said differently, no acid quench is utilized to stop or slow the glyoxalation or stabilize the resulting product. Rather, the conditions of the method herein provide a self-stabilizing gPAM composition that does not require a conventional acid quench to maintain stability and functionality.

It is to be appreciated that the gPAM resin composition prepared via the glyoxalation may be used immediately (e.g. within minutes to hours after being prepared) or instead, owing to the stability of the gPAM resin composition as prepared in the present embodiment, may instead be stored for some time and then utilized (e.g. combined with the aqueous suspension of cellulosic fibers). As introduced above, during such storage time the gPAM resin in the composition may continue to form and/or crosslink via reaction with residual glyoxal present in the aqueous composition in which the gPAM was formed (e.g. the reaction mixture). As such, it is to be understood that the gPAM resin composition is prepared at an initial state defined by a given pH, turbidity, and viscosity, and may comprise a different pH and or turbidity when ultimately utilized (e.g. at an implementation state, defined by a pH, turbidity, and/or viscosity). Moreover, the selection of the implementation state will be influenced by a final state, and the parameters thereof, at which the gPAM resin composition remains stable for use. Additionally, as will be understood in view of the examples and description of the same herein, the particular parameters of the glyoxalation may provide for a change in one or more of the state properties after glyoxalation is ceased, e.g. where the resulting the gPAM resin composition may comprise a stability window in terms of performance in one aspect (e.g. strength additive) while also maintaining performance in another aspect (e.g. drainage). As such, the stability of the gPAM resin composition need not be absolute with respect to all possible properties, but instead may be specific to a desired characteristic or intended use.

For example, in some embodiments, the method comprises determining a stability period over which the gPAM resin composition reaches the final state as defined by a final pH (F_{pH}), turbidity (F_{NTU}), and/or viscosity (F_{η}). In such embodiment, determining the stability period typically comprises determining a maximum change (ApH) between the initial pH (I_{pH}) and the final pH (F_{pH}) over which the gPAM resin composition maintains stability, determining a maximum change (Δ_{NTU}) between the initial turbidity (I_{NTU}) and the final turbidity (F_{NTU}) over which the gPAM resin composition maintains stability, determining a maximum change (Δ_{η}) between the initial viscosity (I_{η}) and the final viscosity (F_{η}) over which the gPAM resin composition maintains stability, or combinations thereof.

For example, in specific embodiments, determining the stability period comprises determining the Δ_{pH}. In some such embodiments, the stability period has a maximum duration less than the time required for the Δ_{pH} to reach a value greater than about 50% of the I_{pH}. In these or other embodiments, determining the stability period comprises determining the Δ_{NTU}. In some such embodiment, the stability period has a maximum duration less than the time required for the Δ_{NTU} to reach a value greater than about 300, alternatively greater than about 200% of the I_{NTU}.

The actual (observed) values of the initial state and final state metrics are not particularly limited beyond the reaction conditions described herein. Rather, it is to be appreciated that the change in such values may be used in the condition selection and stability determinations set forth in the present embodiments. For example, in some embodiments, the initial turbidity (I_{NTU}) is defined as the difference in turbidity from the pre-reaction state to the in-reaction state of the composition, as taught in U.S. Pat. No. 8,222,343B2 referenced above. In this sense, I_{NTU} is not the absolute turbidity at the start of the glyoxalation, but rather represents the change in turbidity of the reaction mixture from the pre-reaction state. In this sense, when describing the Δ_{NTU} (i.e., the change between the initial turbidity (I_{NTU}) and the final turbidity (F_{NTU}), a range of Δ_{NTU} from 10-20 for example would encompass a reaction-based turbidity change. For example, with a per-reaction turbidity of about 100 NTU (absolute), values of 20 I_{NTU} and 20 I_{NTU} are understood to include 120 NTU and 140 NTU (absolute), respectively. Accordingly, it will be readily understood that reference values may need be taken relative to the particular composition and components utilized. Nonetheless, certain ranges are provided below for exemplary reference based on certain embodiments.

In some embodiments, the initial state of the gPAM resin composition is defined by an I_{pH} being at least about 7.5, alternatively at least about 8, alternatively at least about 8.5. In these or other embodiments, the initial state of the gPAM resin composition is defined by an I_{NTU} being less than about 30, alternatively less than about 25, alternatively less than about 20, alternatively less than about 15, alternatively less than about 10, NTU. As described herein, the I_{NTU} may be understood as the change in turbidity from pre-reaction state, such that the values provided need not be absolute turbidity but instead relative to the system being utilized. In these or other embodiments, the initial state of the gPAM resin composition is defined by an In being less than about 100, alternatively less than about 80 cPs (Brookfield, 25° C.; alternatively, Spurlin-Spence).

In certain embodiments, the final state of the gPAM resin composition is defined by an F_{pH} being at least about 6, a F_{NTU} being less than about 77 NTU, a Fn being less than about 100 cPs (Brookfield, 25° C.; alternatively, Spurlin-Spence), or a combination thereof. In some such embodiments, the gPAM resin composition is defined by an Fn being less than about 50 cPs, alternatively less than about 40, alternatively less than about 30, alternatively less than about 25 cPs. For example, in certain embodiments, the gPAM resin composition is defined by an Fn of from about 2 to about 30, alternatively from about 5 to about 30, alternatively from about 5 to about 25, alternatively from about 10 to about 25, alternatively from about 10 to about 20 cPs.

In specific embodiments, at the time of combining the gPAM resin composition with the aqueous suspension of cellulosic fibers the gPAM resin composition comprises a pH of at least about 6.5, alternatively at least about 6.8. In these or other embodiments, at the time of combining the gPAM resin composition with the aqueous suspension of cellulosic fibers the gPAM resin composition comprises a turbidity of less than about 20, alternatively less than about 10, alternatively less than about 5 NTU. In these or yet other embodiments, at the time of combining the gPAM resin composition with the aqueous suspension of cellulosic fibers the gPAM resin composition comprises a viscosity of less than about 100, alternatively less than about 80, cPs (Brookfield; 25° C.). In some such embodiments, at the time of combining the gPAM resin composition with the aqueous suspension of cellulosic fibers, the gPAM resin composition exhibits a viscosity of less than about 50 cPs, alternatively less than about 40, alternatively less than about 30, alternatively less than about 25 cPs. For example, in certain embodiments, the gPAM resin composition at that time exhibits a viscosity of from about 2 to about 30, alternatively from about 5 to about 30, alternatively from about 5 to about 25, alternatively from about 10 to about 25, alternatively from about 10 to about 20 cPs.

In some embodiments, the properties of the initial and final state of the gPAM resin composition are not accurately measurable using typical methods outside of a relatively short time period of the glyoxalation reaction. In such cases, specific quantification methods may be necessary in order to provide reproducibly accurate experimental results. For example, as described below with respect to certain examples, properties of the gPAM resin composition prepared according to specific embodiments provided herein exhibit a drop in viscosity at certain time periods surrounding the glyoxalation method. In such instances, it was found that specific viscometry methods could be used to accurate follow the composition viscosity over the course of the reaction, as compared to methods relying on samples to be drawn, equilibrated, and analyzed after a time delay that was observed to significantly impact the accuracy of measurements taken. Accordingly, while certain viscosity values provided herein may be obtained with particular methods (e.g. Brookfield, at 25° C.), it is to be understood that the viscosity values and ranges provided herein equally apply to the alternative viscosity assessment techniques provided. In this sense, the gPAM resin composition may comprise an initial state and/or final state viscosity obtained via Ubbelohde-type viscometer, or a T-shaped capillary viscometer, such as the Spurlin-Spence viscometer described herein. It is to be appreciated that different viscometry assessments may provide different results on a given sample, as measurements may not correspond at all shear rates or other conditions.

In general, in terms of the method, when combined with the aqueous suspension of cellulosic fibers the gPAM resin composition comprises a final pH greater than half of the initial pH and a final turbidity less than twice the initial turbidity. Said differently, the pH of the gPAM resin composition when combined with the aqueous suspension of cellulosic fibers is at least half of the initial pH, such as at least about 55%, alternatively at least about 60%, alternatively at least about 65% of the initial pH. Additionally, the turbidity of the gPAM resin composition when combined with the aqueous suspension of cellulosic fibers is less than about 300%, alternatively less than about 200% of the initial turbidity, such as less than about 190%, alternatively less than about 180%, alternatively less than about 175%, alternatively less than about 170%, alternatively less than about 165%, alternatively less than about 150% of the initial turbidity. In these or other embodiments, the viscosity of the gPAM resin composition may be used to assess stability over time, with a particular change in viscosity between the initial state and the final state depending on the particular reaction conditions utilized in the glyoxalation as well as the desired gPAM resin being prepared therein.

Without being bound by theory, it is believed that the conditions of the glyoxalation process utilized may generate a high level of reactive aldehyde functionality on the final gPAM resin without creating too many intermolecular crosslinks or excessively building up the gPAM molecular weight and/or the viscosity of the final aqueous gPAM resin composition. It is known that intermolecular crosslinks tend to cause the viscosity to quickly rise, in some instances causing gelling to occur, and reduce final product stability (i.e., shelf life). At the same time, intermolecular crosslinks may be desired to build a higher molecular weight of the final gPAM resin as also described herein. It is also believed that the conditions of the glyoxalation conditions influence the degree of intramolecular crosslinking as well. While not quantified herein, it is believed that certain implementations of the glyoxalation conditions promote increased intramolecular crosslinking over time. Specifically, as demonstrated in the examples herein, prolonged storage of the composition prepared with certain configurations of the glyoxalation process are observed to lose viscosity over time, without an associated increase in turbidity, which is not observed when employing a conventional acid quench following reaction with glyoxal. Accordingly, the present embodiments may be used to obtain a balance between a high-reactivity of the final polymer, the weight percent of gPAM resin in the resulting aqueous composition, the level of residual/unreacted glyoxal in that gPAM composition, and the ageing stability of the final gPAM product prepared. One of skill in the art will appreciate that a high reactivity of the final gPAM can lead to higher wet strengths of paper made with the additive compositions of the present embodiments, and some embodiments the level of wet-strength decay may also be controlled. Likewise, where the high reactivity influences the stability of the prepared additive composition over time, e.g. as described above, the performance may be nonetheless maintained. As demonstrated in the examples herein, such maintained performance may be in the form of added strength to final paper prepared therewith, in the form of increased drainage, or both. Likewise, one of skill in the art will appreciate that such performance may be characterized for other uses of the gPAM-based additive composition In this sense, the present embodiments provide for a robust and highly-tailorable method of preparing gPAM resin compositions, without the use of acid, in a manner not previously known or expected in the art.

The solids of the final gPAM resin in the additive composition, i.e., after glyoxalation, is typically from about 0.1 to 7%, such as from about 0.5 to about 6%, alternatively from about 1 to about 5%. However, amounts outside these ranges may also be targeted, as will be understood by those of skill in the art. For example, solids contents overlapping conventional “high-solids” processes may be obtained. In general, the aforementioned ranges are typical of a low-solids process. The overlap in such ranges will be understood by those of skill in the art in view of the description of the critical concentration above. Likewise, it is to be appreciated that the actual upper limit to the solids content may be defined in terms of the critical concentration, i.e., where the reaction solids are maintained below such critical concentration. Further description of the critical concentration is set forth in U.S. Pat. No. 7,875,676, which is hereby incorporated by reference in its entirety.

The gPAM resin typically has an absolute Mw of at least about 3 megadaltons (MDa). In certain embodiments, the gPAM resin has a Mw of at least about 3.5 MDa, alternatively at least about 4, alternatively at least about 5, alternatively at least about 8, alternatively at least about 10 MDa. The range of Mw is not particularly limited above the bottom values of these ranges noted (i.e., about 3 MDa or above, alternatively about 3.5 MDa or above, etc.). As such, the gPAM resin may have a Mw in the range of from 3 to 50 MDa, such as from 5 to 50, alternatively from 5 to 45, alternatively from 10 to 40 MDa. In specific embodiments, the gPAM resin may have a Mw higher than those listed in the aforementioned ranges. Such gPAM resins may be achieved and provide the benefits of the additive composition disclosed herein. The particular Mw can be selected by one of skill in the art in view of the embodiments shown and described herein, e.g. in view of a desired use or particular application of the additive composition being targeted.

The gPAM resin typically has a radius of gyration (Rg) of at least about 100 nm, and may exhibit a Rg up to about 230 nm in certain embodiments. In some embodiments, the gPAM resin has a Rg of at least about 120 nm, such as at least about 130, alternatively at least about 140, alternatively at least about 150, alternatively at least about 190, alternatively at least about 200, alternatively at least about 220 nm. In specific embodiments, the gPAM resin may have a Rg higher than those listed in the aforementioned ranges.

The gPAM resin typically has a charge density of from about 0.2 to about 3 mEq./g, at pH 7. In some embodiments, the gPAM resin has a charge density of from about 1 to about 3, mEq./g, at pH 7. In specific embodiments, the gPAM resin may have a charge density outside the aforementioned ranges.

The gPAM resin typically has a zeta potential of from about 1 to about 30 mV, at pH 7. In some embodiments, the gPAM resin has a zeta potential of from about 2 to about 30 mV, such as from about 5 to about 30, alternatively from about 5 to about 25, alternatively from about 5 to about 20, alternatively from about 5 to about 15 mV, at pH 7. In specific embodiments, the gPAM resin may have a zeta potential outside the aforementioned ranges.

The particular properties and features of the gPAM resin, including those introduced above, will be appreciated in view of the method and components utilized in the preparation method set forth herein.

The additive composition comprises the gPAM resin and the aqueous media. The aqueous media is not particularly limited, and may comprise, alternatively may be, any aqueous composition compatible with the gPAM resin and/or the components used to prepare the same. In this fashion, the aqueous media may be a water-based solution or suspension, optionally including additional components, such as process water from a papermaking operation, or simply an aqueous carrier vehicle used in the preparation of the gPAM resin composition itself.

Typically, the additive composition comprises the gPAM resin in the aqueous media in functional amount, i.e., in a solids content that maximizes the amount of gPAM resin while maintaining a useful flowable state of the composition. In this sense, the gPAM resin may be present in the additive composition in an amount of from greater than 0 wt. % to less than the gel point of the gPAM resin in the aqueous media. In some embodiments, the gPAM resin is present in an amount of from about 1.2 to about 6%, such as from about 1.2 to about 5, alternatively from about 1.3 to about 4, alternatively from about 1.4 to about 3, alternatively from about 1.95 to about 2.45% based on the aqueous media (i.e., as % solids). However, the amount of gPAM present in the additive composition may be dependent on the amount of cPAM utilized in the glyoxalation method. Furthermore, it is to be appreciated that the gPAM prepared in the glyoxalation reaction may be used as the additive composition (i.e., such that the reaction product of the glyoxalation is the additive composition). Alternatively, the additive composition may be prepared from the reaction product of the glyoxalation, e.g. via dilution, concentration, and/or adding additional components thereto. In typical embodiments, the gPAM is prepared on-site and the additive composition comprises, alternatively is, the direct reaction product from glyoxalating the cPAM (i.e., without further processing/purification).

As introduced above, the additive composition may be prepared as the aqueous suspension immediately prior to being utilized, i.e., where the gPAM resin is prepared in-situ as an aqueous suspension and immediately (or soon after) combined with the aqueous suspension of cellulosic fibers. Such processes are known in the art as “on-site” processes, and are particularly suitable for use in the present embodiments with the cPAM prepolymer and final gPAM resin described herein. That said, it will be appreciated that, depending on the solids content of the additive composition, there no particular limits as the to the storage life, and thus “off-site” preparation may also be utilized.

In general, the additive composition is typically prepared and subsequently combined with a pre-formed aqueous suspension of cellulosic fibers. As introduced above, the time between preparing and using the additive composition may vary. The time between formation of the gPAM resin, the reactive window thereof, the gPAM content in the additive composition, and other factors known in the art, will all be utilized to inform the practical limits on the concentration of a particular gPAM resin in the additive composition of the present embodiments. In general, the present method is to an on-site process, although the storage stability of the additive composition (i.e., the gPAM resin composition) allows for an optional delay between preparation and combination with the aqueous suspension of cellulosic fibers. For example, the gPAM resin may be prepared and introduced to the suspension within a time period suitable for storage, such as within about 30, alternatively about 24, alternatively about 18, alternatively about 10, alternatively about 3 days after being formed. Alternatively, the gPAM resin composition may be combined with the aqueous suspension of cellulosic fibers after at least about 1, alternatively at least about 2, alternatively at least about 5, alternatively at least about 8, alternatively at least about 15 days after being formed. Alternatively, the gPAM resin composition may be combined with the aqueous suspension of cellulosic fibers within 24, alternatively within 18, alternatively within 12, alternatively within 6, alternatively within 3 hours of being formed. As will be appreciated from the examples herein, in some embodiments the gPAM resin composition may be stable and maintain a usable form (e.g. as the additive composition) for a period greater than those above, such as for a time greater than 30 days (e.g. for 2, 3, 4, 5, 6 or more, months).

The additive composition may be used to make paper, which comprises pulp and the gPAM resin. The additive composition used in paper making may lead to beneficial properties, such as, e.g. improved dry strength, temporary wet-strength, permanent wet-strength, wet-strength decay, etc., compared to the same properties when a conventional gPAM resin (i.e., free from repeat units derived from the cationic monomer described herein) is used.

In the paper making process there are multiple steps, generally including: forming an aqueous suspension of cellulosic fibers; addition of additives (e.g. the additive composition) to the suspension; forming a sheet from the fibers; and drying the sheet to give the paper. Additional steps may also be employed. For example, for tissue and towel grades, a forth step of creping or forming a structure of the paper to provide properties such as softness is typically employed. These steps and variations of the process are known to those skilled in the art.

In view of the above, a process of forming paper is also provided herein. The process generally comprises:
(1) providing an aqueous suspension of cellulosic fibers;
(2) combining the additive composition with the aqueous suspension;
(3) forming the cellulosic fibers into a sheet; and
(4) drying the sheet to produce a paper.

In certain embodiments, the additive composition is added to the wet end of a papermaking machine.

As introduced above, the paper making process may further comprise additional steps involving drying, patterning, treating, and/or creping the paper to form a finished paper product. Finished paper products are exemplified by tissue (e.g. bath, facial, etc.), towel, paperboard, etc., which can be consumer grade, commercial grade, etc., and made from any combination of virgin and/or recycled fiber.

One aspect of the present embodiments provides a method of preparing an aqueous cellulosic composition, comprising:
preparing a self-stabilized glyoxalated polyacrylamide (gPAM) resin composition by selectively glyoxalating a cationic polyacrylamide (cPAM) prepolymer in an aqueous reaction mixture having a total solids of less than about 6% and a pH of at least about 7.5 to give the gPAM resin composition at an initial state defined by an initial pH (I_{pH}), turbidity (I_{NTU}), and viscosity (I_{η});
determining a stability period over which the gPAM resin composition reaches a final state defined by a final pH (F_{pH}), turbidity (F_{NTU}), and viscosity (F_{η}); and
within the stability period and free from any addition of acid thereto, combining the gPAM resin composition with an aqueous suspension of cellulosic fibers, thereby preparing the aqueous cellulosic composition.

Also provided is the method of the preceding aspect, wherein determining the stability period comprises:
(i) determining a maximum change (Δ_{pH}) between the initial pH (I_{pH}) and the final pH (F_{pH}) over which the gPAM resin composition maintains stability;
(ii) determining a maximum change (Δ_{NTU}) between the initial turbidity (I_{NTU}) and the final turbidity (F_{NTU}) over which the gPAM resin composition maintains stability;
(iii) determining a maximum change (Δ_{η}) between the initial viscosity (I_{η}) and the final viscosity (F_{η}) over which the gPAM resin composition maintains stability; or
(iv) any combination of (i)-(iii), where maintaining stability is defined by the gPAM resin composition comprising less than about 8, alternatively less than about 6% total solids.

Also provided is the method of any one of the preceding aspects, wherein determining the stability period comprises determining the Δ_{pH}, and wherein the stability period has a maximum duration less than the time required for the Δ_{pH} to reach a value greater than about 50% of the I_{pH}.

Also provided is the method of any one of the preceding aspects, wherein determining the stability period comprises determining the Δ_{NTU}, and wherein the stability period has a maximum duration less than the time required for the Δ_{NTU} to reach a value greater than about 300, alternatively greater than about 200% of the I_{NTU}.

Also provided is the method of any one of the preceding aspects, wherein the initial state of the gPAM resin composition is further defined by:
(i) the I_{pH} being at least about 7.5, alternatively at least about 8, alternatively at least about 8.5;
(ii) the I_{NTU} being less than about 20 NTU, optionally less than about 20 NTU from a pre-reaction turbidity of the cPAM prepolymer in the aqueous reaction mixture;
(iii) the In being less than about 100, alternatively less than about 80 cPs; or
(iv) any combination of (i)-(iii).

Also provided is the method of any one of the preceding aspects, wherein at the time of combining the gPAM resin composition with the aqueous suspension of cellulosic fibers the gPAM resin composition comprises:
(i) a pH of at least about 6.5, alternatively at least about 6.8;
(ii) a turbidity of less than about 20, alternatively less than about 10, alternatively less than about 5 NTU;
(iii) a viscosity of less than about 100, alternatively less than about 80, cPs; or
(iv) any combination of (i)-(iii).

Also provided is the method of any one of the preceding aspects, wherein the final state of the gPAM resin composition is further defined by:
(i) the F_{pH} being at least about 6;
(ii) the F_{NTU} being less than about 77 NTU;
(iii) the Fn being less than about 100 cPs; or
(iv) any combination of (i)-(iii).

Also provided is the method of any one of the preceding aspects, wherein the stability period is at least about 30 min, alternatively at least about 1 hour, alternatively at least about 6 hours, alternatively at least about 12 hours, alternatively at least about 1 day, alternatively at least about 2 days, alternatively at least about 7 days, alternatively at least about 14 days.

Also provided is the method of any one of the preceding aspects,, wherein the stability period is from at least about 30 min to about 30 days, alternatively at least about 1 hour to about 25 days, alternatively at least about 1 hour to about 21 days.

Also provided is the method of any one of the preceding aspects, wherein the gPAM resin composition is combined with the aqueous suspension of cellulosic fibers within about 30 days, alternatively within about 24 days, alternatively within about 18 days, alternatively within about 10 days, alternatively within about 3 days after being formed.

Also provided is the method of any one of the preceding aspects, wherein the gPAM resin composition is combined with the aqueous suspension of cellulosic fibers after at least about 1 day, alternatively after at least about 2 days, alternatively after at least about 5 days, alternatively after at least about 8 days, alternatively after at least about 15 days of being formed.

Also provided is the method of any one of the preceding aspects, wherein the gPAM resin composition is combined with the aqueous suspension of cellulosic fibers within about 24 hours, alternatively within about 18 hours, alternatively within about 12 hours, alternatively within about 6 hours, alternatively within about 3 hours of being formed.

Also provided is the method of any one of the preceding aspects, wherein the cPAM prepolymer and the glyoxal are reacted: (i) in a dry weight (w/w) ratio of from about 70:30 to about 95:5, alternatively from about 80:20 to about 90:10.

Also provided is the method of any one of the preceding aspects, wherein the cPAM prepolymer comprises the reaction product of:
(A1) an acrylamide (AM) monomer;
(A2) a cationic monomer; and optionally, (A3) one or more additional ethylenically unsaturated monomer(s).

Also provided is the method of the preceding aspect, further comprising preparing the cPAM prepolymer, wherein preparing the cPAM prepolymer comprises reacting the AM monomer (A1), the cationic monomer (A2), and optionally the one or more additional ethylenically unsaturated monomer(s) (A3) in the presence of a chain transfer agent. Also provided is the method of either of the two preceding aspects, wherein:
(i) the AM monomer (A1) comprises acrylamide;
(ii) the cationic monomer (A2) comprises diallyldimethylammonium chloride (DADMAC);
(iii) the one or more additional ethylenically unsaturated monomer(s) (A3), when present, are selected from vinyl amides, styrenes, alkyl acrylates, vinyl acetates, and vinyl carboxylic acids, esters, or salts thereof; or
(iv) any combination of (i)-(iii).

Also provided is the method of any one of the preceding aspects, wherein the cPAM prepolymer has a reduced specific viscosity (RSV) of from about 0.2 to about 2.0, alternatively from about 0.5 to about 1.8, alternatively from about 0.6 to about 1.6 dL/g.

Also provided is the method of any one of the preceding aspects, wherein the cPAM prepolymer comprises a cationic monomer content of at least about 4, alternatively of at least about 10, alternatively of at least about 15, alternatively of at least about 20 mol %.

Also provided is the method of any one of the preceding aspects, wherein the cPAM prepolymer has a weight average molecular weight (Mw) of at least about 5,000 Da, alternatively at least about 20,000 Da, alternatively from about 20,000 to 500,000 Da, alternatively from about 50,000 to about 250,000 Da . . .

Also provided is the method of any one of the preceding aspects, wherein the glyoxalating is further defined as an on-site process.

In accordance with another aspect of present embodiments, a process of forming paper is further provided, said process comprising:
(1) providing an aqueous cellulosic composition prepared according to the method of any one preceding claim;
(2) forming the cellulosic fibers into a sheet; and
(3) drying the sheet to produce a paper.

Also provided is the process of the preceding aspect, wherein the aqueous cellulosic composition exhibits a drainage performance of at least about 80, alternatively at least about 90, alternatively at least about 95% of a substantially similar composition prepared using an acid-quenched gPAM resin composition.

Also provided is the process of any one of the preceding aspects, wherein the paper exhibits a compression strength (Ring Crush) of at least about 80, alternatively at least about 90, alternatively at least about 95, alternatively at least about 98, alternatively at least about 99% of a substantially similar paper prepared using an aqueous cellulosic composition comprising an acid-quenched gPAM resin composition.

Also provided is a method based on any one of the preceding aspects, wherein the gPAM resin composition is combined with the aqueous suspension of cellulosic fibers in the wet end of a paper machine, optionally via spraying the gPAM resin composition into the wet end of the paper machine comprising the aqueous suspension of cellulosic fibers.

In one aspect, a self-stabilized glyoxalated polyacrylamide (gPAM) resin composition is also provided, consisting essentially of an aqueous reaction product of a cationic polyacrylamide (cPAM) prepolymer and glyoxal carried out in an aqueous reaction mixture having a total solids of less than a critical concentration of the gPAM resin and a pH of at least about 7.5, wherein the cPAM prepolymer comprises a weight average molecular weight (Mw) of at least about 5,000 Da and a cationic monomer content of at least about 4, alternatively at least about 10 mol %;
wherein the reaction product is prepared without addition of any acid; and
wherein the gPAM resin composition maintains a substantially single phase for a stability period of at least about 1, alternatively at least about 3, alternatively at least about 7, alternatively at least about 14 days.

Also provided is the composition of the preceding aspect, wherein the cPAM prepolymer and the glyoxal are reacted: (i) in a dry weight (w/w) ratio of from about 70:30 to about 95:5, alternatively from about 80:20 to about 90:10.

Also provided is the composition of at least one of the preceding aspects, wherein the cPAM prepolymer comprises the reaction product of:
(A1) an acrylamide (AM) monomer;
(A2) a cationic monomer; and optionally, (A3) one or more additional ethylenically unsaturated monomer(s).

Also provided is the composition of at least one of the preceding aspects, wherein the cPAM prepolymer is the reaction product of the AM monomer (A1), the cationic monomer (A2), and optionally the one or more additional ethylenically unsaturated monomer(s) (A3, reacted together in the presence of a chain transfer agent.

Also provided is the composition of at least one of the preceding aspects, wherein:
(i) the AM monomer (A1) comprises acrylamide;
(ii) the cationic monomer (A2) comprises diallyldimethylammonium chloride (DADMAC);
(iii) the one or more additional ethylenically unsaturated monomer(s) (A3), when present, are selected from vinyl amides, styrenes, alkyl acrylates, vinyl acetates, and vinyl carboxylic acids, esters, or salts thereof; or
(iv) any combination of (i)-(iii).

Also provided is the composition of at least one of the preceding aspects, wherein the cPAM prepolymer has a reduced specific viscosity (RSV) of from about 0.2 to about 2.0, alternatively from about 0.5 to about 1.8, alternatively from about 0.6 to about 1.6 dL/g.

Also provided is the composition of at least one of the preceding aspects, wherein the cPAM prepolymer comprises a cationic monomer content of at least about 15, alternatively of at least about 20 mol %.

Also provided is the composition of at least one of the preceding aspects, wherein the cPAM prepolymer has a Mw of at least about 20,000 Da.

Also provided is the composition of at least one of the preceding aspects, prepared via on-site glyoxalation of the cPAM prepolymer with the glyoxal.

### Examples

The following examples, illustrating embodiments of this disclosure, are intended to illustrate and not to limit the invention. Unless otherwise noted, all solvents, substrates, and reagents are purchased or otherwise obtained from various commercial suppliers (e.g. Sigma-Aldrich, VWR, Alfa Aesar) and utilized as received (i.e., without further purification) or as in a form used conventionally in the art.

### Determination of Polymer Properties

The Reduced Specific Viscosity (RSV) of the cPAM (prepolymer) is determined at 0.25 wt. % in 1 M ammonium chloride using a Poly Visc (Cannon® MiniPV®-HX).

Charge density is determined using a BTG Particle Charge Detector PCD-06. A sample is prepared by diluting a solution of the polymer in a phosphate buffer (5 mM; pH 7) to make a 0.5% solution. A 1 g portion of the 0.5% polymer solution and 9 g of a 5 mM pH 7 phosphate buffer is added to the sample chamber. Using an autotitrator, the sample is then titrated with 0.001 M PVSK (potassium salt of polyvinyl sulfate) until the sample charge has been neutralized.
The cPAM Mw may be determined using relative SEC against known standards.
The GPAM Mw may be determined by batch MALS or AF4 MALS.
   General Cationic Acrylamide (cPAM) Prepolymer Synthesis

A reaction flask is charged with DI water, diallyldimethylammonium chloride (DADMAC), a pH modifier, and a chain transfer agent. To the reaction flask two external feeds are connected, one containing acrylamide, the other containing sodium metabisulfite (SMBS) and the chain transfer reagent. The reaction mixture is warmed to 35° C., then ammonium persulfate (APS) and sodium bromate are added, followed by starting the feeds. The acrylamide feed is set to be added over 135 minutes, the SMBS feed is set to be added over 195 minutes. During the acrylamide feed, the reaction is gradually heated through an external heating source at ˜0.4° C./min up to 90° C. After the conclusion of the acrylamide feed, a second portion of APS is added and the reaction is held at 90° C. for one hour. The amount of DADMAC is varied as necessary to make a prepolymer with the acquired amount of cationic monomer. The molecular weight of the prepolymer may be manipulated by increasing or reducing the amount of chain transfer agent as necessary.

Three cPAM prepolymers are prepared with varying cationic monomer content according to the procedure above. Characteristics and properties of the cPAM prepolymers are set forth in table below:

| cPAM | DADMAC | RSV | Charge Density |
|---|---|---|---|
| Prepolymer | (Mol %) | (dL/g) | (mEq./g) |
| CPAM 1 | 4.1 | 0.80 | 0.76 |
| CPAM 2 | 12.8 | 1.09 | 1.91 |
| CPAM 3 | 20.5 | 1.21 | 2.8 |

Preparation & Performance Examples: cPAM and gPAM resins

Various gPAM resins are prepared using cPAM prepolymers CPAM 1-3 and analyzed according to the methods above. Specific parameters and properties of gPAM resins are set forth in the tables below.

All examples below are prepared, performed/ran, and stored at ambient temperature (22-24° C.) unless otherwise stated. pH and turbidity are measured for all samples at the intervals listed in the various tables below. For each of Examples 1-3, the pH and turbidity are measured within 1 minute of removing the indicated 100 mL aliquot from the reaction mixture and recorded as T=0 in the corresponding tables. Brookfield viscosity was measured after temperature equilibration of the sample, which was typically around 30-60 min after collection, with preference for shorter time periods when possible. As described in detail further below, a different type of viscosity assessment was selected for later examples to standardize data collection.

### Example 1: Synthesis of Glyoxalated Polyacrylamide (gPAM) Using CPAM-1

CPAM 1 is charged to a reaction flask and diluted with DI water so the concentration of the prepolymer in water is 1.7%, to which is added glyoxal at 15:85 dry w: w ratio relative to the prepolymer and a start turbidity is measured. The pH is increased to ˜10 using dilute NaOH and this pH is maintained until the turbidity has increased by ˜6 NTU from the start turbidity.

Turbidity and pH measurements recorded during the glyoxalation reaction are set forth in the table below:

| Time (min) | pH | Turbidity (NTU) |
|---|---|---|
| 0 | 3.88 | 2.84 |
| 2 | 9.97 | 3.1 |
| 4 | 9.97 | 3.41 |
| 6 | 9.98 | 3.84 |
| 8 | 9.97 | 4.32 |
| 10 | 9.98 | 4.84 |
| 12 | 9.98 | 5.43 |
| 14 | 9.98 | 6.74 |
| 15 | 9.97 | 7.43 |
| 17 | 9.98 | 8.4 |

A 100 mL sample is removed from the reaction and is designated as “GPAM 1-Acid Free” (Example 1), and initial state measurements (pH, turbidity, viscosity) are recorded.

In the time it took to remove the sample for Example 1, the turbidity of the remaining reaction had increased to ˜10 NTU over the initial. The remainder of the reaction is quenched by reducing the pH to 4 with dilute sulfuric acid. The resulting mixture is designated as “GPAM 1-Standard” (Comparative Example 1).

The resulting compositions of Example 1 and Comparative Example 1 are monitored for 18 days to assess storage stability. The results of the monitoring are set forth in the table below.

| | |
|---|---|
| Example 1 | Comparative Ex. 1 |

| Time | | Turbidity | | Turbidity |
|---|---|---|---|---|
| (min) | pH | (NTU) | pH | (NTU) |
| 0 | 9.85 | 11.7 | 3.69 | 9.14 |
| 5 | 9.77 | 13.1 | — | — |
| 10 | 9.71 | 16.3 | — | — |
| 15 | 9.67 | 17 | — | — |
| 30 | 9.57 | 22 | — | — |
| 45 | 9.52 | 25.9 | — | — |
| 60 | 9.46 | 30.1 | — | — |
| 120 | 9.25 | 37.8 | — | — |
| 354 | 8.81 | 51.6 | 4.27 | 9.35 |
| 1376 | 8.25 | 65.5 | 3.97 | 9.58 |
| 2826 | 7.78 | 70.9 | 4.02 | 9.12 |
| 4267 | 6.93 | 74.8 | 4.02 | 9.31 |
| 8618 | 6.93 | 74.8 | 4.07 | 9.74 |
| 11489 | 6.82 | 76.6 | 4.19 | 10.2 |
| 25769 | 6.85 | 82.2 | 4.13 | 9.37 |

### Example 2: Synthesis of Glyoxalated Polyacrylamide (gPAM) Using CPAM-2

CPAM 2 is charged to a reaction flask and diluted with DI water so the concentration of the polymer in water is 1.7%, to which is added glyoxal at 15:85 dry w: w ratio relative to the prepolymer and a start turbidity is measured. The pH is increased to 10.2 using dilute NaOH and this pH is maintained for 1000 seconds, with the turbidity being measured periodically.

Turbidity and pH measurements recorded during the reaction are set forth in the table below:

| Time (min) | pH | Turbidity (NTU) |
|---|---|---|
| 0 | 4.02 | 1.62 |
| 2 | 10.19 | 2.57 |
| 4 | 10.19 | 2.32 |
| 6 | 10.19 | 2.48 |
| 8 | 10.2 | 2.83 |
| 10 | 10.19 | 3.39 |
| 12 | 10.19 | 3.35 |
| 14 | 10.19 | 3.33 |

After 15 min, a 100 mL sample is removed from the reaction and is designated as “GPAM 2-Acid Free” (Example 2), and initial state measurements (pH, turbidity, viscosity) are recorded.

The remainder of the reaction is quenched by reducing the pH to 4 with dilute sulfuric acid. The resulting mixture is designated as “GPAM 2-Standard” (Comparative Example 2).

The resulting compositions of Example 2 and Comparative Example 2 are monitored for 18 days to assess storage stability. The results of the monitoring are set forth in the table below.

| | |
|---|---|
| Example 2 | Comparative Ex. 2 |

| Time | | Turbidity | | Turbidity |
|---|---|---|---|---|
| (min) | pH | (NTU) | pH | (NTU) |
| 0 | — | — | 4.41 | 4.52 |
| 5 | 9.81 | 4.41 | — | — |
| 10 | 9.91 | 4.8 | — | — |
| 15 | 9.91 | 5.08 | — | — |
| 30 | 9.83 | 5.5 | — | — |
| 45 | 9.76 | 5.79 | — | — |
| 60 | 9.71 | 6.11 | — | — |
| 80 | 9.65 | 6.78 | — | — |
| 91 | 9.65 | 6.78 | 4.96 | 4.45 |
| 1101 | 8.53 | 8.46 | 4.96 | 4.86 |
| 2536 | 8.03 | 8.65 | 5.03 | 4.29 |
| 3988 | 7.73 | 8.91 | 5.28 | 5.75 |
| 8354 | 7.37 | 9.34 | 5.07 | 4.21 |
| 11233 | 7.22 | 9.04 | 5.43 | 4.43 |
| 25486 | 7 | 9.83 | 5.42 | 4.95 |

### Example 3: Synthesis of Glyoxalated Polyacrylamide (gPAM) Using CPAM-3

CPAM 3 is charged to a reaction flask and diluted with DI water so the concentration of the polymer in water is 2.3%, to which is added glyoxal at 15:85 dry w: w ratio relative to the prepolymer and an initial turbidity is measured. The pH is increased to 10.2 using dilute NaOH and this pH is maintained for 1000 seconds, with the turbidity being measured periodically.

Turbidity and pH measurements recorded during the reaction are set forth in the table below:

| Time (min) | pH | Turbidity (NTU) |
|---|---|---|
| 0 | 4.13 | 2.24 |
| 2 | 10.19 | 2.06 |
| 4 | 10.18 | 1.66 |
| 6 | 10.19 | 1.69 |
| 8 | 10.19 | 2.07 |
| 10 | 10.19 | 1.87 |
| 12 | 10.19 | 3.26 |
| 14 | 10.2 | 2.81 |

After 15 min, a 100 mL sample is removed from the reaction and is designated as “GPAM 3-Acid Free” (Example 3), and initial state measurements (pH, turbidity, viscosity) are recorded.

The remainder of the reaction is quenched by reducing the pH to 4 with dilute sulfuric acid. The resulting mixture is designated as “GPAM 3-Standard” (Comparative Example 3).

The resulting compositions of Example 3 and Comparative Example 3 are monitored for 18 days to assess storage stability. The results of the monitoring are set forth in the table below.

| | |
|---|---|
| Example 3 | Comparative Ex. 3 |

| Time | | Turbidity | | Turbidity |
|---|---|---|---|---|
| (min) | pH | (NTU) | pH | (NTU) |
| 0 | 10.19 | 2.8 | 4.24 | 2.13 |
| 5 | 10.04 | 2.88 | — | — |
| 10 | 10.03 | 2.79 | — | — |
| 15 | 9.97 | 2.19 | — | — |
| 30 | 9.9 | 2.22 | — | — |
| 45 | 9.82 | 2.4 | — | — |
| 60 | 9.75 | 2.38 | — | — |
| 80 | 9.63 | 2.62 | — | — |
| 191 | 9.09 | 2.41 | 4.53 | 2.14 |
| 1210 | 8.24 | 2.86 | 4.56 | 1.79 |
| 2639 | 7.74 | 3.18 | 4.56 | 3.23 |
| 4096 | 7.54 | 3.31 | 4.52 | 2.11 |
| 8456 | 7.15 | 3.07 | 4.72 | 2.19 |
| 11327 | 7.05 | 3.79 | 4.75 | 2.5 |
| 25600 | 6.88 | 4.42 | 4.87 | 3.13 |

### Dynamic Drainage Analysis (DDA).

American old corrugated container (AOCC) was refined to a CSF of ˜400 mL and then diluted with DI water to a consistency of 0.9%. To the diluted pulp was added sodium sulfate until the solution conductivity reached ˜2000 μS/cm. The pH of the pulp was adjusted to 7 using concentrated sulfuric acid, followed by the addition of 2.5 wt % of oxidized starch (GPC D-28F). Drainage time was measured using a Dynamic Drainage Analyzer 4 instrument from PulpEye. A 60-mesh screen with a 95 mm cross-sectional filtration diameter was used. The analyzer applies a 300 mbar vacuum and measures the time between application of vacuum and the vacuum break point, or when air breaks through the thickening fiber mat. To perform the test, 750 mL of furnish was charged into the sample receptacle and the pulp was stirred. After 15 seconds of stirring, a polymer additive was charged to the stirring pulp slurry, and the stirring was continued for an additional 10 seconds. The instrument then stops stirring, applies vacuum, and records the amount of time it takes for the pressure to stabilize (pressure vs. time).

Dynamic Drainage Analysis (DDA) was performed on Examples 2-3 (aged 16 days, each) and Comparative Examples 2-3 against a control (blank) according to the procedure above. The results of the DDA are set forth in the table below. As higher cationic materials are used for more demanding drainage applications, Example 1 (4 mol % cationic content) was not assessed via DDA.

| Polymer Additive | Average (s) | Standard Deviation (s) |
|---|---|---|
| None (control) | 30.53 | 0.46 |
| Example 2 (16 days) | 28.13 | 0.05 |
| Example 3 (16 days) | 23.91 | 0.61 |
| Comp. Example 2 | 23.88 | 0.48 |
| Comp. Example 3 | 22.91 | 0.17 |

As shown, both Example 2 (13 mol % cationic content) and Example 3 (20 mol % cationic content) provide improved drainage over the control even after 16 days of storage. Example 3 provides stable drainage performance commensurate with the absolute performance of Comparative Examples 2-3 (acid quenched), even after the prolonged time frame.

### Handsheet Preparation

AOCC was refined in a cycle beater as received until the CSF was ˜400 mL. Handsheets were produced using a noble and wood handsheet mold. The quantity of pulp necessary to form ten 33 1b/1000 sqft sheets is added to the porportioner and diluted to 9 L using conditioned water (pH 7, 2000 μS/cm). The Polymer Additive are added at the listed dosage followed by a commercial cPAM retention aid at 0.25 lb/ton, with about 30 seconds between each addition. A sheet is made by dewatering the required amount of treated pulp using a forming wire and deckle box, then pressing the sheet (60 PSI), and finally drying the sheet on a drum dryer (245° F.). A total of six sheets are made for each condition. Each condition was repeated in at least duplicate, resulting in 12 total sheets per condition.

### Compression Strength Performance of the Paper

Ring crush was measured with a Testing Machines Inc. Model 17-76-00-0001 using TAPPI method T 822 om-16. The strength performance data were normalized to basis weight and are reported relative to the performance of a blank sample, which was treated with all additives except for the gPAM.

Strength performance was assessed for Examples 1-3 (aged 7 days, each) and Comparative Examples 1-3 against a control (blank) according to the procedure above. The results of the analyses are set forth in the table.

| Additive | Average (lb) | Standard Deviation (lb) |
|---|---|---|
| None | 66.55 | 2.28 |
| Example 1 | 74.90 | 2.91 |
| Example 2 | 73.44 | 2.79 |
| Example 3 | 73.83 | 2.76 |
| Comp. Example 1 | 77.72 | 2.51 |
| Comp. Example 2 | 73.15 | 3.56 |
| Comp. Example 3 | 73.97 | 2.97 |

As shown, all Examples (1-3) provide improved strength over the control even after 7 days of storage. Exemplary resins (e.g. Examples 2-3) prepared according to the process of the present embodiments provide comparable strength performance to the corresponding comparative resins prepared using a traditional acid quench. This strength performance is maintained after 7 days, evidencing the stability across a range of cationic contents.

In view of the above, the additive composition can be readily envisioned for use in enhancing machine productivity. Additionally, the gPAM resins therein may be used to give good dry strength.

### Examples 4-5: Synthesis of Glyoxalated Polyacrylamides (gPAM)

Glyoxalation conditions are analyzed over a series of conditions according to the procedures described herein. Specifically, a cPAM Prepolymer was reacted with glyoxal in the same manner as set forth in Example 3 above with varying End Conditions. At a time endpoint, two 100 g aliquots are removed from the reaction and processed as described below. The remainder of the reaction is quenched by reducing the pH to 4 with dilute sulfuric acid (Acid Quench). Of the two 100 g aliquots removed prior to the quench, the first aliquot is set aside with no further processing (Acid Free), and the second aliquot is diluted with 10 g of DI water (Acid Free, 10% Dil.).

All samples are then aged at ambient temperature (22-25° C.) and monitored for 10 days, with analysis following the procedures set forth above. Dynamic Drainage Analysis (DDA) is performed after aging the samples for 72 hours, and again after aging for 240 hours. All data is taken at 6 1b/ton chemical dose.

The parameters and results of Examples 4-5 are set forth below.

| Example | cPAM Prepolymer | End Conditions |
|---|---|---|
| 4A | CPAM 2 | Acid Quench |
| 4B | CPAM 2 | Acid Free |
| 4C | CPAM 2 | Acid Free, 10% Dil. |
| 5A | CPAM 3 | Acid Quench |
| 5B | CPAM 3 | Acid Free |
| 5C | CPAM 3 | Acid Free, 10% Dil. |

| | | Change After 72 Hours | | | | | | |
|---|---|---|---|---|---|---|---|---|
| | | | Turbidity | Δ | | | Avg. DDA | Δ DDA |
| Ex. | pH | Δ pH | (NTU) | Turbidity | BV | Δ BV | (sec) | (rel blank) |
| 4A | 5.56 | 0.44 | 2.53 | −0.37 | 8.88 | 0.72 | 37.34 +/− 0.28 | 27.20% |
| 4B | 7.49 | −2.71 | 3.57 | −0.42 | 5.74 | −0.8 | 41.33 +/− 0.77 | 19.40% |
| 4C | 7.48 | −2.72 | 3.19 | −0.33 | 5.99 | −0.43 | 45.41 +/− 0.31 | 11.50% |
| 5A | 4.14 | 0.02 | 3.91 | 0 | 19.3 | −0.2 | 30.9 +/− 0.82 | 39.80% |
| 5B | 7.43 | −2.77 | 4.87 | −0.08 | 14.1 | −0.9 | 34.87 +/− 0.63 | 32.00% |
| 5C | 7.47 | −2.73 | 4.09 | −0.54 | 11.6 | −1.4 | 35.68 +/− 1.13 | 30.40% |
| | | | | | | Blank: | 51.3 +/− 0.6 | 0.00% |

| | | Change after 240 hours | | | | | | |
|---|---|---|---|---|---|---|---|---|
| | | | Turbidity | Δ | | | Avg. DDA | Δ DDA |
| Ex. | pH | Δ pH | (NTU) | Turbidity | BV | Δ BV | (sec) | (rel blank) |
| 4A | 6.25 | 1.13 | 2.34 | −0.56 | 9.04 | 0.88 | 36.38 +/− 2.12 | 29.20% |
| 4B | 6.93 | −3.27 | 2.89 | −1.1 | 5.57 | −0.97 | 43.67 +/− 0.93 | 15.10% |
| 4C | 6.94 | −3.26 | 2.99 | −0.53 | 5.86 | −0.56 | 42.55 +/− 0.32 | 17.30% |
| 5A | 4.23 | 0.11 | 4.31 | 0.4 | 18.7 | −0.8 | 31.31 +/− 0.11 | 39.10% |
| 5B | 6.92 | −3.28 | 4.87 | −0.61 | 13.8 | −1.4 | 36.11 +/− 1.44 | 29.80% |
| 5C | 6.98 | −3.22 | 4.11 | −0.54 | 10.8 | −2.2 | 37.75 +/− 0.15 | 26.60% |
| | | | | | | Blank: | 51.42 +/− 1.38 | 0.00% |

As shown, the pH and BV fall over time in both acid-free and conditions, including when a 10% dilution is made. The relative viscosity drop between the acid-free conditions is partially attributed to the dilution, where the viscosity drop in the nondiluted reaction holds over time in a similar fashion to the acid-quenched reaction.

Notably, the undiluted acid-free conditions provided improved performance relative to the diluted conditions at all time points assessed. This observation supports the glyoxalation conditions of present embodiment providing a product having a longer period of stability than comparative conditions (i.e., dilution), which is a surprising and unexpected result given the typical results of dilution on the stability/reactivity of the concentration-dependent reactions. It was also observed that the a relatively higher loss in BV correlates to relative loss in performance, even with little observable change in turbidity.

### Example 6: Synthesis and Performance of Glyoxalated Polyacrylamides (gPAM)

gPAM performance across glyoxalation conditions is analyzed over a series of conditions according to the procedures described herein. Specifically, a cPAM Prepolymer was reacted with glyoxal in the same manner as set forth in Example 3 above with varying End Conditions.

For Examples 6B, 6D, and 6E using CPAM 1, turbidity is used to measure the endpoint, and when 10 NTU is reached, two 100 g aliquots are removed from the reaction and processed as described below. The remainder of the reaction is quenched by reducing the pH to 4 with dilute sulfuric acid (Acid Quench; Ex. 6B). Of the two 100 g aliquots removed prior to the quench, the first aliquot is set aside with no further processing (Acid Free; Ex. 6E), and the second aliquot is diluted with 10 g of DI water (Acid Free, 10% Dil. Ex. 6D).

For Examples 6C, and 6F using CPAM 3, at a time endpoint a 100 g aliquot is removed from the reaction and diluted with 10 g of DI water (Acid Free, 10% Dil.; Ex. 6F). The remainder of the reaction is quenched by reducing the pH to 4 with dilute sulfuric acid (Acid Quench; Ex. 6C). Of the two 100 g aliquots removed prior to the quench, the first aliquot is set aside with no further processing (Acid Free), and the second aliquot is diluted with 10 g of DI water (Acid Free, 10% Dil.).

Handsheets are made from a blank and the gPAM polymers from Examples 6B-6F after aging samples for 48 hours, and again after 192 hours, according to the procedure above. The handsheets are assessed for compression strength performance according to the procedure above.

Parameters and performance results of Examples 6A-6F are shown below. For Examples 6A (Blank), 6B, and 6C, performance values are reported as the average of the values obtained from both the 48 hour and 192 hour experiments.

| Example: | 6A (Blank) | 6B | 6C |
|---|---|---|---|
| cPAM Prepolymer: | NA | CPAM 1 | CPAM 3 |
| End Conditions: | NA | Acid Quench | Acid Quench |
| Ring Crush (lb force), | 72.06 +/− 2.55 | 79.77 +/− 2.38 | 77.86 +/− 2.84 |
| no aging: | | | |
| % Change from Blank, | 0.00% | 10.71% | 8.05% |
| no aging: | | | |
| Example: | 6D | 6E | 6F |
| cPAM Prepolymer: | CPAM 1 | CPAM 1 | CPAM 3 |
| End Conditions: | Acid Free, | Acid Free | Acid Free, |
| | 10% Dil. | | 10% Dil. |
| Ring Crush (lb force), | 78.03 +/− 1.87 | 79.91 +/− 2.01 | 77.57 +/− 2.39 |
| 48 hr: | | | |
| % Change from | 8.30% | 10.91% | 7.65% |
| Blank, 48 hr: | | | |
| Ring Crush (lb force), | 77.43 +/− 2.16 | 76.03 +/− 2.30 | 77.87 +/− 2.97 |
| 192 hr: | | | |
| % Change from | 7.45% | 5.51% | 8.07% |
| Blank, 192 hr: | | | |

As shown, diluting with water after the reaction completes is associated with a reduction in performance relative to the acid free conditions. However, diluting the sample prior to ending pH maintenance does not always harm performance, with higher charge on the gPAM improving the stability/tolerance to such dilution steps in terms of strength performance, while draining performance is observed to be more sensitive to dilution conditions.

### Viscosity Assessment, Spurlin-Spence Tube Flow Viscosity

A Spurlin-Spence (SS) tube flow viscometer is used to monitor and assess intra-reaction viscosity changes. The SS instrument is a T-shaped capillary viscometer that comprises a vertical glass tube intersecting with a center of a second horizontal glass tube to make a “T” shaped device. The shaft of vertical glass tube includes a measuring bulb and is marked with calibration lines or timing marks above and below the glass bulb, similar to the design used by conventional suspended-level (e.g. Ubbelohde-type) viscometer. The bottom of the vertical glass tube is a capillary barrel with a diameter of 1.46 mm. Each side of the horizontal tube includes a valve (e.g. stopcock).

To take a viscosity measurement, a sample is drawn from the reaction mixture into the vertical tube by opening a valve on one side of the horizontal tube and pulling the sample up via pipette bulb on that open valve side, until the sample reaches the top of the vertical tube. The valve with the pipette bulb is closed, and the other valve is opened, allowing the sample to fall freely through the viscometer tube. When the sample reaches the top marked line (above the measuring bulb), a stopwatch is started, and the sample allowed to continue to flow through the bulb. The stopwatch is stopped when the sample reaches the bottom marked line (below the measuring bulb), the stopwatch is stopped, and the time is recorded (SS Viscosity).

During the experiments described herein, it was observed that standard initial viscosity measurements could not be adequately taken in all instances due to the temperature equilibration time required between sample collection and measurement. Specifically, a rapid decrease in viscosity can be observed in the acid-free glyoxalation conditions following cessation of the pH maintenance from the reaction of the cPAM prepolymer with glyoxal, as described above. This change in viscosity is not characteristic of comparative glyoxalation conditions. Accordingly, the SS Viscosity was utilized to provide a standardized assessment of the viscosity change over time during the glyoxalation conditions of the present embodiments, as well as the comparative conditions set forth herein.

### Example 7: Synthesis and Analysis of Glyoxalated Polyacrylamides (gPAM) Using CPAM 3

gPAM performance across glyoxalation conditions is analyzed over a series of conditions according to the procedures described herein. Specifically, cPAM 3 is reacted with glyoxal in the same manner as set forth in Example 3 above, with the progress of the reaction is monitored using a 1.46 mm tube flow viscometer (SS) as described in the procedure above. The pH of the reaction is maintained with dilute base at a target Reaction pH until the tube flow viscosity is observed to be leveling off (total reaction time “T”), at which point a sample is removed (Acid Free; Examples 7A & 7D) and the remainder is quenched with dilute sulfuric acid until the pH reaches 4 (Quenched; Examples 7B & 7D).

All samples are then analyzed via Dynamic Drainage Analysis (DDA) according to the procedure above, with data obtained at 6 1b/ton chemical dose.

The parameters and results of Examples 7A-7D are set forth below.

| Example: | 7A (Blank) | 7A | 7B | 7C | 7D |
|---|---|---|---|---|---|
| cPAM Prepolymer: | NA | CPAM 3 | CPAM 3 | CPAM 3 | CPAM 3 |
| End Conditions: | NA | Acid Free | Quenched | Acid Free | Quenched |
| Reaction pH: | NA | 9.2 | 9.2 | 10.2 | 10.2 |
| Reaction Time (T; | NA | 97 | 97 | 17 | 17 |
| min): | | | | | |
| SS Viscosity, at T | NA | 20.7 | 18.5 | 22.1 | 19 |
| (sec): | | | | | |
| SS Viscosity, at T + 96 | NA | 16.3 | 18.6 | 14.4 | 19 |
| hrs (sec): | | | | | |
| Δ SS (%): | NA | −21.10% | 0.70% | −34.80% | −0.10% |
| Avg. DDA (sec): | 31.6 +/− 1.1 | 21.8 +/− 0.3 | 20.5 +/− 0.7 | 19.4 +/− 0.0 | 22.3 +/− 0.1 |
| Δ DDA (rel blank): | 0.00% | 31.00% | 35.20% | 38.60% | 29.60% |
| Δ Performance vs | N/A | −4.18% | | | −9.00% |
| Blank, rel. Quenched: | | | | | |

As shown, the acid-free conditions provide nearly the same performance as the acid-quench under the conditions provided. The performance is affected by the reaction pH, with a higher relative loss in performance at higher pH after aging. This observation is consistent with the larger reduction in viscosity being tied to lower performance, as demonstrated above.

### Example 8: Synthesis and Analysis of Glyoxalated Polyacrylamides (gPAM) Using CPAM 3

gPAM performance across glyoxalation conditions is analyzed over a series of conditions according to the procedures described herein. Specifically, cPAM 3 is reacted with glyoxal in the same manner as set forth in Example 3 above, with the progress of the reaction is monitored using a 1.46 mm tube flow viscometer as described in the procedure above. The pH of the reaction is maintained with dilute base at a target Reaction pH until the tube flow viscosity is observed to be leveling off, at which point the pH maintenance is stopped and the tube flow viscosity is measured for another 120 minutes.

It has been previously observed that when the glyoxalation reaction is run at the critical concentration, the viscosity normally peaks, levels out, then falls, with the optimal reaction time being at the peak. When the glyoxalation reaction is run at lower pH the viscosity build takes longer but the “leveling” period also lasts longer, if the material is not quenched at the peak and pH maintenance is removed the viscosity is observed to fall.

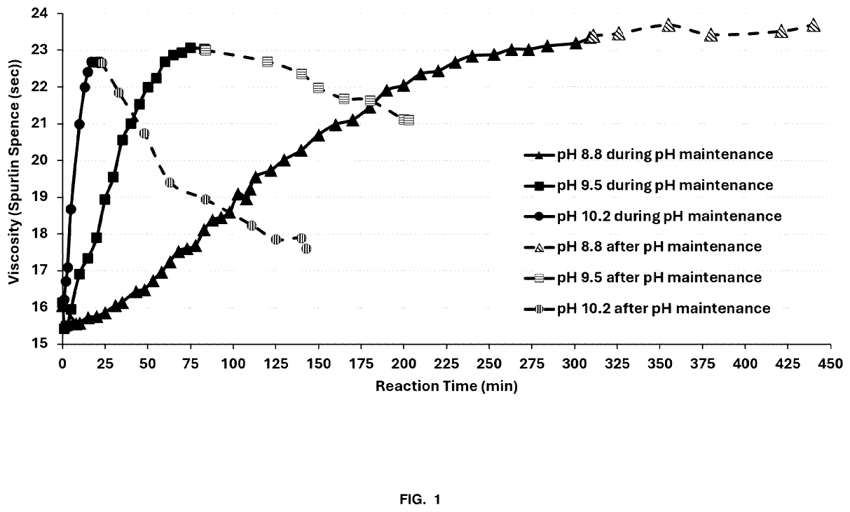

As demonstrated, with the results plotted in the chart shown in FIG. 1, where the change in viscosity after pH maintenance is removed is signified by the dashed line, it was surprisingly observed that using relatively lower pH conditions with the acid-free methods provided herein can provides higher stability without need to quench, while maintaining performance. In other words, the method provides an acid-free process to prepare stable glyoxalated resins with adequate strength and draining performance characteristics.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims. Moreover, all combinations of the aforementioned components, compositions, method steps, formulation steps, etc. are hereby expressly contemplated for use herein in various non-limiting embodiments even if such combinations are not expressly described in the same or similar paragraphs.

With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the ranges and subranges enumerated herein sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. An individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims. Lastly, it will be understood that the term “about” with regard to any of the particular numbers and ranges described herein is used to designate values within standard error, equivalent function, efficacy, final loading, etc., as understood by those of skill in the art with relevant conventional techniques and processes for formulation and/or utilizing compounds and compositions such as those described herein. As such, the term “about” may designate a value within 10, alternatively within 5, alternatively within 1, alternatively within 0.5, alternatively within 0.1, % of the enumerated value or range.

While the present disclosure has been described with respect to particular embodiments thereof, it is apparent that numerous other forms and modifications will be obvious to those skilled in the art. The appended claims and this disclosure generally should be construed to cover all such obvious forms and modifications, which are within the true scope of the present disclosure.

1. A method of preparing an aqueous cellulosic composition, comprising:
preparing a self-stabilized glyoxalated polyacrylamide (gPAM) resin composition by selectively glyoxalating a cationic polyacrylamide (cPAM) prepolymer in an aqueous reaction mixture having a total solids of less than about 6% and a pH of at least about 7.5 to give the gPAM resin composition at an initial state defined by an initial pH (I_{pH}), turbidity (I_{NTU}), and viscosity (I_{η});
determining a stability period over which the gPAM resin composition reaches a final state defined by a final pH (F_{pH}), turbidity (F_{NTU}), and viscosity (F_{η}); and
within the stability period and free from any addition of acid thereto, combining the gPAM resin composition with an aqueous suspension of cellulosic fibers, thereby preparing the aqueous cellulosic composition.

2. The method of claim 1, wherein determining the stability period comprises:
(i) determining a maximum change (Δ_{pH}) between the initial pH (I_{pH}) and the final pH (F_{pH}) over which the gPAM resin composition maintains stability;
(ii) determining a maximum change (Δ_{NTU}) between the initial turbidity (I_{NTU}) and the final turbidity (F_{NTU}) over which the gPAM resin composition maintains stability;
(iii) determining a maximum change (Δ_{η}) between the initial viscosity (I_{η}) and the final viscosity (F_{η}) over which the gPAM resin composition maintains stability; or
(iv) any combination of (i)-(iii),
where maintaining stability is defined by the gPAM resin composition comprising less than about 8% total solids.

3. The method of claim 2, wherein determining the stability period comprises:
(i) determining the Δ_{pH}, and wherein the stability period has a maximum duration less than the time required for the Δ_{pH} to reach a value greater than about 50% of the I_{pH};
(ii) determining the Δ_{NTU}, and wherein the stability period has a maximum duration less than the time required for the Δ_{NTU} to reach a value greater than about 300% of the I_{NTU}; or
(iii) both (i) and (ii).

4. The method of claim 1, wherein the initial state of the gPAM resin composition is further defined by:
(i) the I_{pH} being at least about 7.5;
(ii) the I_{NTU} being less than about 20 NTU from a pre-reaction turbidity of the cPAM prepolymer in the aqueous reaction mixture;
(iii) the I_{η} being less than about 100 cPs; or
(iv) any combination of (i)-(iii).

5. The method of claim 1, wherein at the time of combining the gPAM resin composition with the aqueous suspension of cellulosic fibers the gPAM resin composition comprises:
(i) a pH of at least about 6.5;
(ii) a turbidity of less than about 100 NTU;
(iii) a viscosity of less than about 100 cPs; or
(iv) any combination of (i)-(iii).

6. The method of claim 1, wherein the final state of the gPAM resin composition is further defined by:
(i) the F_{pH} being at least about 6;
(ii) the F_{NTU} being less than about 77 NTU;
(iii) the F_{η} being less than about 100 cPs; or
(iv) any combination of (i)-(iii).

7. The method of claim 1, wherein the stability period is at least about 30 min.

8. The method claim 1, wherein the gPAM resin composition is combined with the aqueous suspension of cellulosic fibers after at least about 1 day and within about 30 days of being formed.

9. The method claim 1, wherein; the cPAM prepolymer and the glyoxal are reacted in a dry weight (w/w) ratio of from about 70:30 to about 95:5.

10. The method of claim 1, wherein the cPAM prepolymer comprises the reaction product of:
(A1) an acrylamide (AM) monomer;
(A2) a cationic monomer; and
optionally, (A3) one or more additional ethylenically unsaturated monomer(s).

11. The method of claim 10, further comprising preparing the cPAM prepolymer, wherein preparing the cPAM prepolymer comprises reacting the AM monomer (A1), the cationic monomer (A2), and optionally the one or more additional ethylenically unsaturated monomer(s) (A3) in the presence of a chain transfer agent.

12. The method of claim 11, wherein:
(i) the AM monomer (A1) comprises acrylamide;
(ii) the cationic monomer (A2) comprises diallyldimethylammonium chloride (DADMAC);
(iii) the one or more additional ethylenically unsaturated monomer(s) (A3), when present, are selected from vinyl amides, styrenes, alkyl acrylates, vinyl acetates, and vinyl carboxylic acids, esters, or salts thereof; or
(iv) any combination of (i)-(iii).

13. The method of any claim 1, wherein the cPAM prepolymer comprises: (i) a reduced specific viscosity (RSV) of from about 0.2 to about 2.0 dL/g; (ii) a cationic monomer content of at least about 4 mol %; (iii) a weight average molecular weight (Mw) of at least about 5,000 Da;
or (iv) any combination of (i)-(iii).

14. The method of claim 1, wherein the glyoxalating is further defined as an on-site process.

15. A process of forming paper, said process comprising:
(1) providing an aqueous cellulosic composition prepared according to the method of claim 1;
(2) forming the cellulosic fibers into a sheet; and
(3) drying the sheet to produce a paper.

16. The process of claim 15, wherein in preparing the aqueous cellulosic composition the gPAM resin composition is combined with the aqueous suspension of cellulosic fibers in the wet end of a paper machine, optionally via spraying the gPAM resin composition into the wet end of the paper machine comprising the aqueous suspension of cellulosic fibers.

17. The process of claim 15, wherein the aqueous cellulosic composition exhibits a drainage performance of at least about 80% of a substantially similar composition prepared using an acid-quenched gPAM resin composition.

18. The process of claim 15, wherein the paper exhibits a compression strength (Ring Crush) of at least about 80% of a substantially similar paper prepared using an aqueous cellulosic composition comprising an acid-quenched gPAM resin composition.

19. A self-stabilized glyoxalated polyacrylamide (gPAM) resin composition, consisting essentially of an aqueous reaction product of a cationic polyacrylamide (cPAM) prepolymer and glyoxal carried out in an aqueous reaction mixture having a total solids of less than a critical concentration of the gPAM resin and a pH of at least about 7.5,
wherein the cPAM prepolymer comprises a weight average molecular weight (Mw) of at least about 5,000 Da and a cationic monomer content of at least about 4 mol %;
wherein the reaction product is prepared without addition of any acid; and
wherein the gPAM resin composition maintains a substantially single phase for a stability period of at least about 1 day.

20. The composition of claim 19, prepared via on-site glyoxalation of the cPAM prepolymer with the glyoxal.
